(19) United States
(12) Patent Application Publication
(10) Pub. No.: US 2014/0329207 A1
(43) Pub. Date: Nov. 6, 2014

(54) CONSUMPTION REGULATION

(71) Applicants: Peter Glen Coorey, Lantau Island (HK); Sandra Leanne Comer, Lantau (HK)

(72) Inventors: Peter Glen Coorey, Lantau Island (HK); Sandra Leanne Comer, Lantau (HK)

(21) Appl. No.: 13/874,907

(22) Filed: May 1, 2013

(51) Int. Cl. G09B 19/00

(52) U.S. Cl. CPC G09B 19/0092
USPC 434/127

(57) ABSTRACT

There is disclosed an apparatus for regulation of user consumption. In an embodiment, the apparatus includes a processor, a memory component, an input/output component, a hydration schedule component, a meal schedule component, a consumption speed regulator, and a profile component. The meal schedule component includes one or more meal prompt generators configured to present one or more meal prompts at times relevant to consumption of meals. The consumption speed regulator includes a chewing pacer configured to present a perceivable pulse that repeats a pre-determined number of times. The profile component is configured to store information about the user and provide the information to at least the hydration schedule component and the meal schedule component for respective scheduling of hydration prompts and meal prompts. Other embodiments are also disclosed.

### BACKGROUND

For decades, if not centuries, overweight persons have struggled to reduce their weight. Known solutions to these predicaments include strict calorie restriction, strict food choice limitations, medications, supplements, surgery and excessive exercising. None of these solutions have been successful at accomplishing real, long-term change while some of them are, in fact, counter-productive. For example, strict calorie restriction frequently induces slowed metabolism and increased efficiency in conversion of food into body fat. Meanwhile, underweight persons have struggled to increase their body weight and, furthermore, otherwise healthy persons have struggled to maintain proper hydration.

### SUMMARY

An apparatus for regulation of user consumption includes a processor, a memory component, an input/output component, a hydration schedule component, a meal schedule component, a consumption speed regulator and a profile component. The meal schedule component includes one or more meal prompt generators capable of presenting one or more meal prompts at times relevant to consumption of meals. The consumption speed regulator includes a chewing pacer capable of presenting a perceivable pulse that repeats a predetermined number of times. The profile component is capable of storing information about the user and providing the information to at least the hydration schedule component and the meal schedule component for respective scheduling of hydration prompts and meal prompts.

### BRIEF DESCRIPTION OF THE FIGURES

FIG. 1 illustrates an example installation of an apparatus in accordance with embodiments of the disclosure on a computing device.

FIG. 2 illustrates an example of a logic system for a consumption regulator apparatus in accordance with an embodiment of the disclosure.

FIG. 3 illustrates an example of a consumption speed regulation component in accordance with a first embodiment of the disclosure.

FIG. 4 illustrates an example of a meal schedule component in accordance with an embodiment of the disclosure.

FIG. 5 illustrates an example of a consumption speed regulation component in accordance with a second embodiment of the disclosure.

FIG. 6 illustrates example of a meal frequency regulation process in accordance with an embodiment of the disclosure.

FIG. 7 illustrates an example of a consumption speed regulation process in accordance with an embodiment of the disclosure.

FIG. 8 illustrates an example of a second serving regulation process in accordance with an embodiment of the disclosure.

FIG. 9 illustrates an example of a snack regulation process in accordance with an embodiment of the disclosure.

### DETAILED DESCRIPTION

As described in detail in the following, an apparatus facilitates both weight loss in overweight users and weight gain in underweight users by regulating caloric intake. The apparatus has the further advantage of assisting users with fluid intake for proper hydration. User personal parameters, environmental factors and performance are taken into account to establish a routine for regulating the speed and frequency of both foods and liquids.

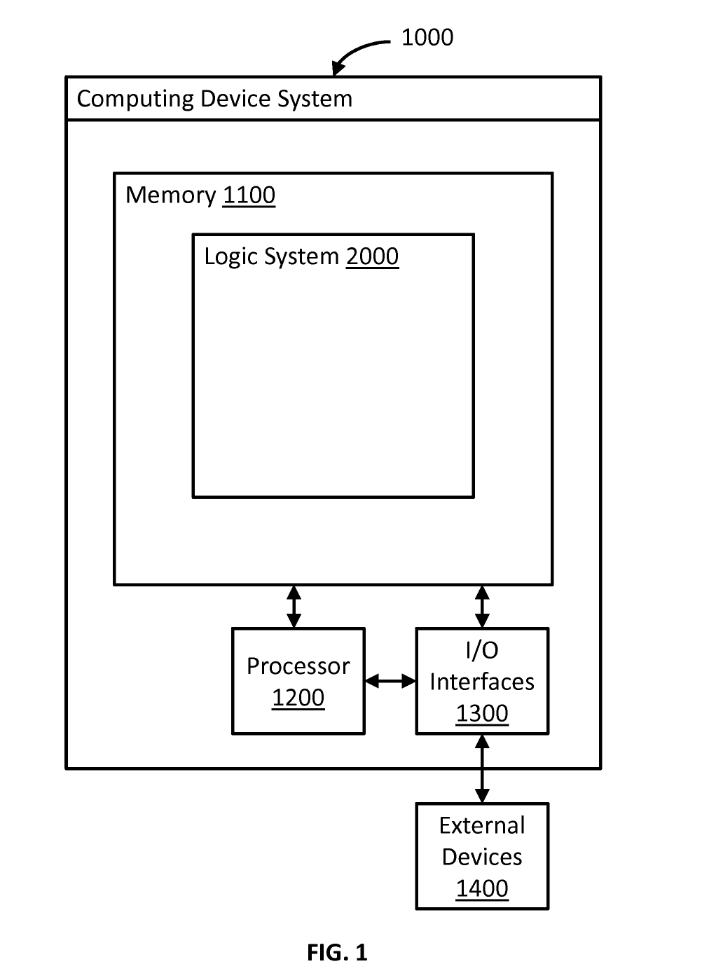

As shown in FIG. 1, the logic system 2000 of a consumption regulator apparatus may be implemented through the use of a computing device system generally indicated at 1000 having a memory 1100 in which logic system 2000 is stored, a processor 1200 for executing instructions encoded within logic system 2000 and input/output interfaces 1300 for receiving instructions from processor 1200 to provide output to external devices 1400 or receive input from external devices.

The computing device system 1000 may be any device capable of executing computer readable program code stored in memory 1100 including by not limited to a desktop computer, a laptop computer, a tablet computer, a personal digital assistant or a smartphone. In some embodiments, the computing device is one that is readily transported by the user to assist the user with consumption regulation wherever the user goes. In some embodiments, the computing device may be provided in the form of a wristwatch wearable by the user.

As memory 1100, any combination of one or more computer readable media may be used. The computer readable medium may be a computer readable storage medium or a computer readable signal medium.

Computer readable storage media usable within the computing device system 1000 may include but are not limited to electronic, magnetic, optical, electromagnetic, infrared, or semiconductor systems, apparatuses, or devices, or any suitable combination thereof. Specific examples include, but are not limited to, electrical connections having one or more wires; portable computer diskettes; hard disks; random access memories (RAM); read-only memories (ROM); erasable, programmable read-only memories (EPROM or Flash memory); optical fibers; portable compact disc read-only memories (CD-ROM); optical storage devices; magnetic storage devices; and combinations thereof. In various embodiments, a computer readable storage medium may be any tangible, non-transitory medium capable of containing, or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical or a combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to wireless, wireline, optical fiber cable, RF, or any combination of these.

Computer program code included within logic system 2000 and capable of carrying out operations for aspects of the consumption regulator may be written in any combination of one or more programming languages, including an object oriented programming language such as Java, Smalltalk, C++ or the like and conventional procedural programming languages, such as the “C” programming language or similar programming languages. The program code may execute entirely on the user's computing device system, partly on the user's computing device system, or entirely on a remote computer or server connected to the user's computing device system through any type of network, including a local area network (LAN) or a wide area network (WAN). Alternatively, the connection may be made to an external computing device system through the Internet using an Internet Service Provider.

Input/output interfaces 1300 may include, but are not limited to, keyboards, pointing devices, gesture interpreting devices, touchscreens and other displays, printers, and audio speakers which are capable of operative coupling to the computing device system 1000 either directly or through intervening I/O.

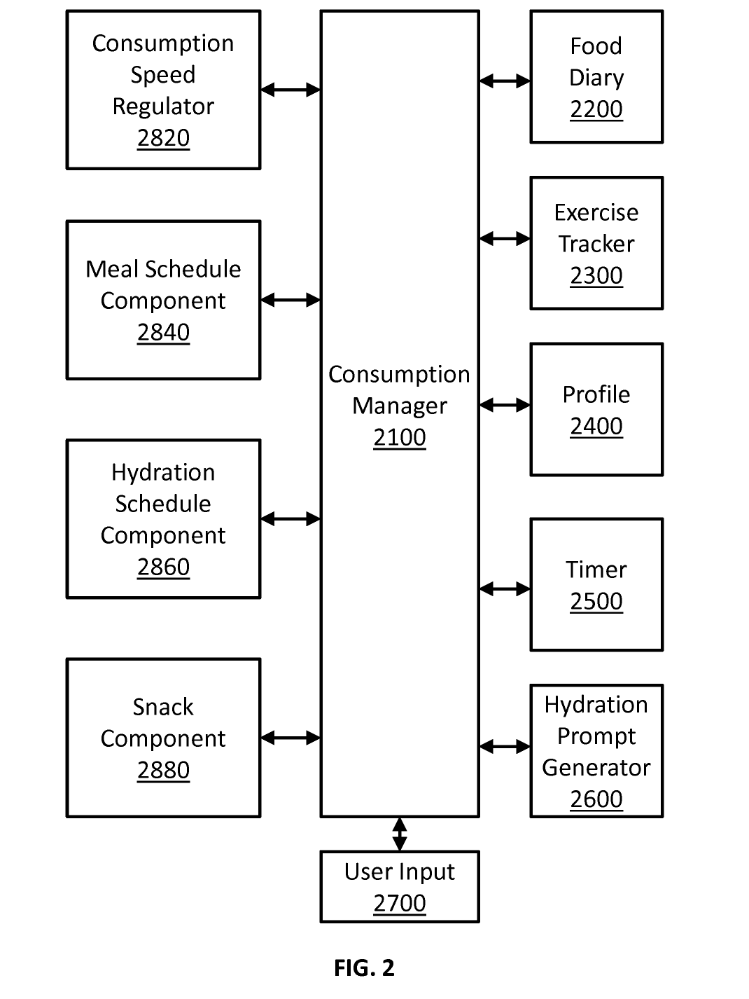

As shown by way of example in FIG. 2, the logic system 2000 (FIG. 1) includes a number of components for performing tasks to facilitate regulation of a user's consumption. The logic system may be generally managed by a consumption manager 2100 (FIG. 2) which delegates actions to one or more of the various components in accordance with user input and criteria pre-programmed as, for example, instructions executable by a computing device system such as computing device system 1000 (FIG. 1).

It should be understood that each component illustrated in FIG. 2, and combinations thereof, are capable of implementation by computer readable program code in the form of instructions. These instructions may be provided to a processor such as processor 1200, which may be a component of a general purpose computing device system, special purpose computing device system, or other programmable data processing apparatus to produce a machine, such that the instructions, which execute via the processor of the computing device system or other programmable data processing apparatus, create means for implementing functions of the components.

The computer readable program code in the form of instructions may also be stored in a computer readable medium that can direct a computing device system or other programmable data processing apparatus such that the instructions produce an article of manufacture including instructions which implement functions components.

Before using the logic system 2000 (FIG. 1) to regulate consumption, a user provides personal information to a profile 2400 (FIG. 2) through the consumption manager 2100 and user input 2700. This provision of personal information may be considered building a personal profile and may be facilitated by presentation, to the user, of a series of prompts for particular user information to be entered into a series of virtual input boxes for subsequent storage in a number of virtual storage containers. Information input by the user may include but is not limited to user age, user sex, user weight, user fitness, current user health issues, whether the user smokes and how much, and characteristics of the user's environment such as location of residence, whether the user sleeps in an environment having air conditioning, central heating, or both, and whether the user works in an environment having air conditioning, central heating, or both.

Having built a profile 2400, the user is ready to begin regulation of consumption using logic system 2000 and computing device 1000. The user starts by initiating the meal schedule and hydration schedule components 2840, 2860 by, for example, pushing a button. Upon initiation, the schedule components 2840 and 2860 begin counting down to times at which the user will be prompted to consume a meal or to hydrate. These times will be established according to information stored within the user's profile 2400 and relayed to the schedule components 2840 and 2860 through the consumption manager 2100.

Countdown is facilitated by the use of a timer 2500. For example, the meal schedule component 2840 may compute a frequency of meal consumption based upon information stored in profile 2400 and then use timer 2500 to count down to times corresponding with this established frequency. In some embodiments, the meal schedule component 2840 can be designed to wake a user an amount of time after the user provides input indicating the beginning of their night's sleep. The amount of time may be, for example, eight hours. In these embodiments, the user will be prompted to hydrate shortly after awaking and then also prompted to consume a meal within a set time of waking.

In some embodiments, components illustrated in FIG. 2 may be combined or further subdivided to simplify or expedite implementation by a computing device system. For example, in some embodiments, the hydration prompt generator 2600 may be a sub-component of each of the meal schedule component 2840 and hydration schedule component 2860. Furthermore, in some embodiments, consumption manager 2100 may be eliminated such that components depicted in FIG. 2 interact directly with the user, with one another, or both with the user and one another.

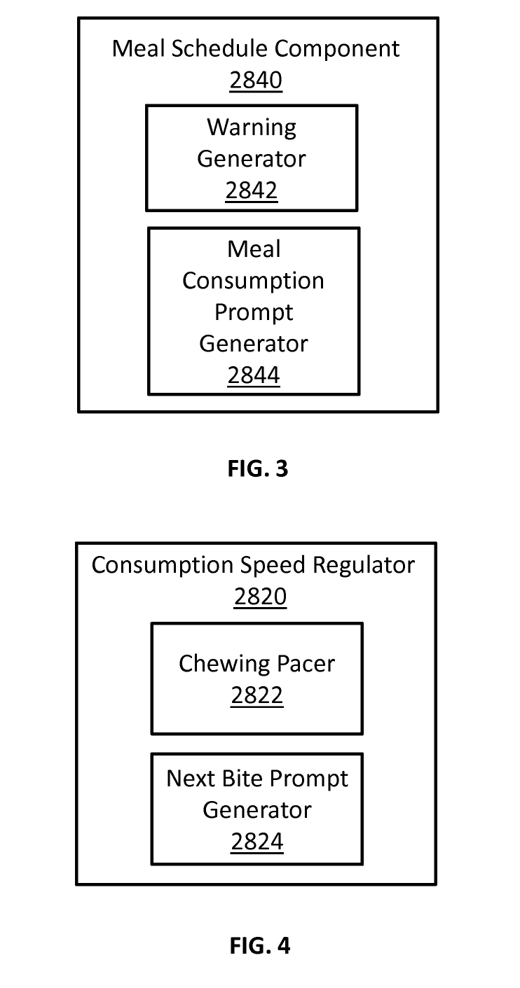

With references to FIG. 3, the meal schedule component 2840 includes one or more meal prompt generators capable of presenting one or more meal prompts to the user at times relevant to consumption of meals. Meal prompt generators include warning prompt generators 2842 capable of presenting warning prompts at pre-determined intervals prior to optimum times for meal consumption and begin consumption prompt generators 2844 capable of presenting a begin consumption prompt at the optimum times for meal consumption.

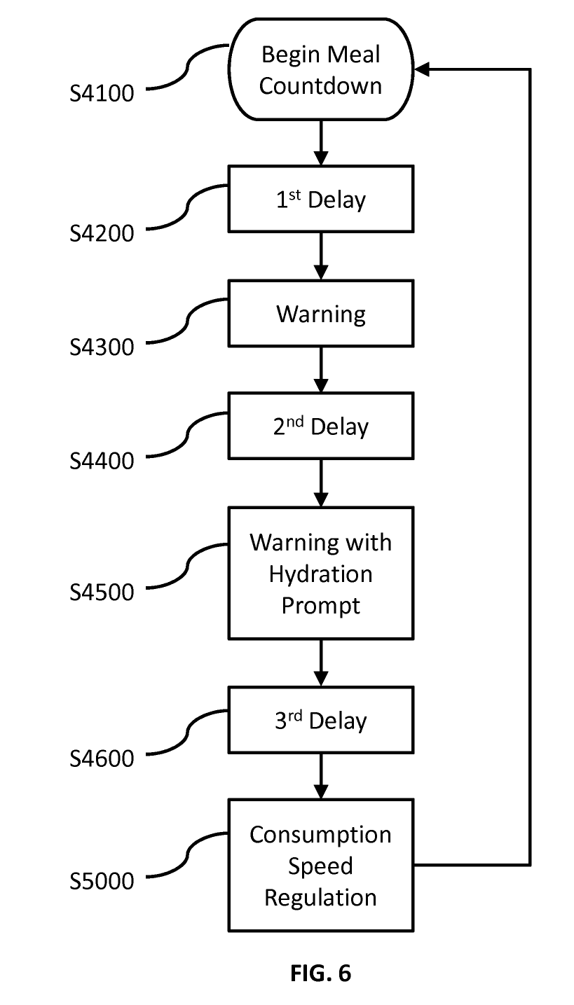

An example of meal schedule component regulation will now be described with reference to FIG. 6. Meal countdown begins according to step S4100 as a result of the user turning on the consumption regulator apparatus or pressing a start or “begin meal countdown” button. Using the timer 2500 (FIG. 2), after a first delay S4200, the meal schedule component 2840 (FIG. 3) warns a user with an alert a time prior to optimal time for meal consumption according to step S4300. After a second delay S4400, meal schedule component 2840 (FIG. 3) alerts the user again at step S4500. At the time of this second warning, the meal schedule component 2840 (FIG. 3) also recruits hydration prompt generator 2600 to provide the user with a prompt to hydrate. A third delay is initiated after the second warning at step S4600. After elapse of this third delay, meal schedule component 2840 presents the user with a begin meal consumption prompt through use of consumption prompt generator 2844 and sends a signal through consumption manager 2100 (FIG. 2) to initiate consumption speed regulator 2822 (FIG. 2) according to step S5000. The above meal prompts generated by warning prompt generator 2842 and consumption prompt generator 2844 (FIG. 3) may include an alert such as an audible beep, a vibration or a blinking light in combination with a verbal message such as “Eat a meal in 30 minutes!” or “Begin eating now!” Verbal messages may be audible, readable or both.

In one embodiment, the begin meal consumption prompts, and, therefore, the warning prompts and hydration prompts are activated at four-hour intervals. However, the actual time may vary depending on the user's profile, the model of the consumption regulator or additional user input not provided to the profile.

When the user has their meal in front of him or her, and is ready to begin meal consumption, he or she can provide input to user input 2700 (FIG. 2) indicating a readiness to begin meal consumption. This may be accomplished, for example, by pressing a button which may be of a physical or an on-screen, virtual variety. The user input 2700 then causes initiation of consumption speed regulator 2820 by communication through consumption manager 2100.

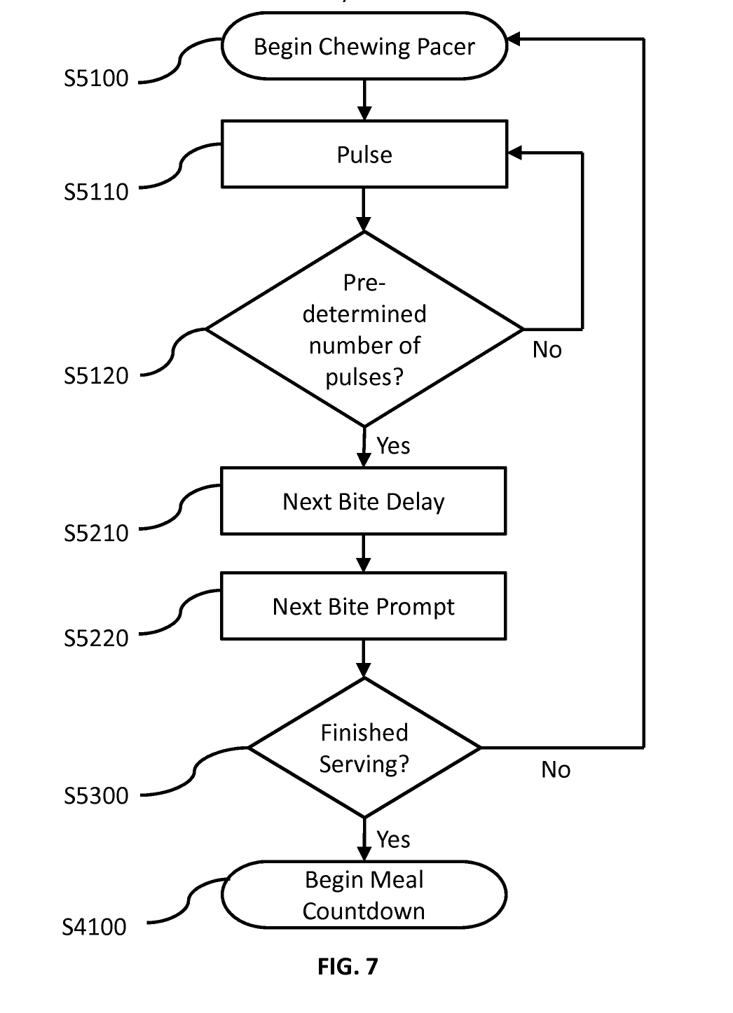

The consumption speed regulator 2820, as shown, for example, in FIG. 4 includes a chewing pacer 2822 and a next bite prompt generator 2824. Upon indication by the user that he or she is ready to begin consuming their meal, the chewing pacer 2822 paces chewing of the user by presenting a perceivable pulse that repeats a pre-determined number of times. The process of regulating a user's speed of meal consumption is depicted in FIG. 7. At step S5100, the chewing pacer 2822 (FIG. 4) begins and a perceivable pulse is started at step S5110. After each pulse, the chewing pacer 2822 (FIG. 4) checks if the required number of pulses have been generated at step S5120. If the required number have not been generated, the chewing pacer 2822 (FIG. 4) loops back to step S5110 to generate additional pulses. According to a set of instructions provided with the consumption regulator, the user should chew once for each pulse and swallow after the programmed number of iterations, which may be, for example, thirty-five. The pulse may be one or more of a variety of forms that are perceivable by the user. For example, the pulse may be a beep or may be a blinking light, a throbbing vibration or a combination of these.

After the required number of pulses have been generated, the process proceeds to the next bite delay step S5210 during which delay, according to consumption regulator instructions, the user should not take another bite. After elapse of the delay, the next bite prompt generator 2824 (FIG. 4) presents the user with a prompt to take their next bite as indicated at step S5220. The prompt generated may be anything clearly perceivable and understandable to the user including but not limited to a beep or blinking light different from that corresponding with the pulse or an audible or readable verbal message or a combination of these. In some embodiments, the user may be prompted to take their next bite by the cessation of a perceivable signal presented to the user between the conclusion of the chewing pacer pulses at step S5120 and the conclusion of the next bite delay S5210. For example, a light may be illuminated continuously or a tone may be played continuously as long as the next bite delay is active.

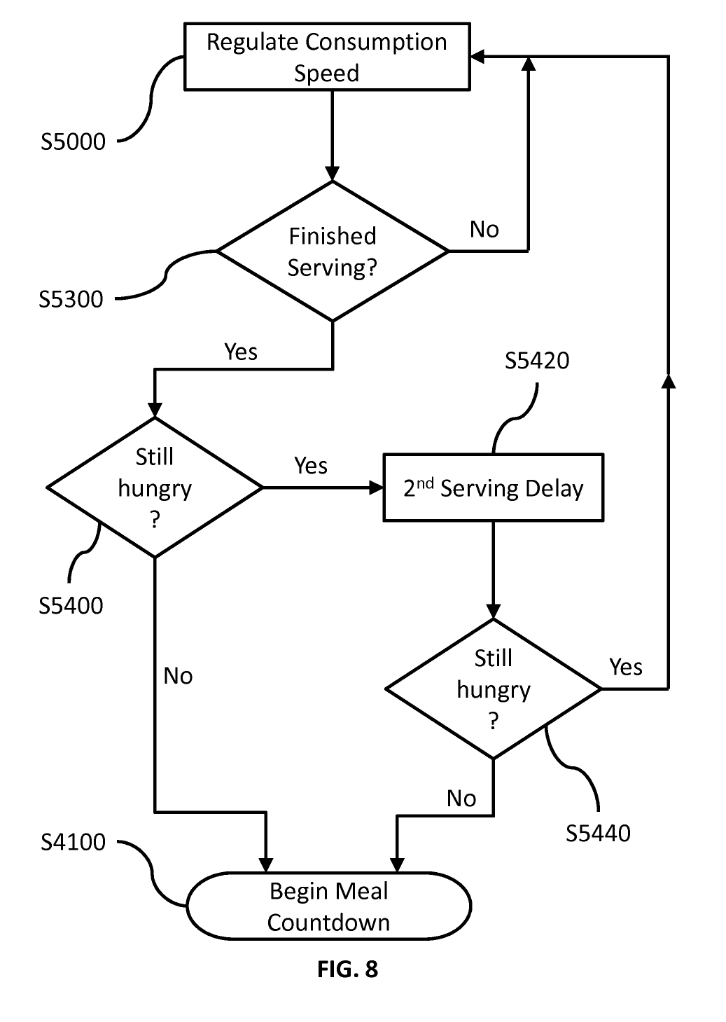

At the time of the next bite prompt S5220, the user may have the opportunity to indicate to the consumption regulator that they have finished their serving at step S5300. If the user indicates they have not finished their serving, the consumption speed regulator 2820 (FIG. 4) returns to pacing the user's chewing at step S5100. When the user indicates he or she has finished a serving, the consumption speed regulator 2820 (FIG. 4) may conclude by sending a finished eating signal to the consumption manager 2100 (FIG. 2) which, in turn, begins countdown of the meal schedule component 2840 (FIG. 2) through use of timer 2500 (FIG. 2) according to a return to step S4100. Alternatively, the user may indicate continued hunger at step S5400 illustrated in FIG. 8. If the user is still hungry after consuming his or her first serving, the consumption regulator advances to a second serving delay step S5420 which prompts the user to wait an amount of time before beginning consumption of a second serving. After this delay has elapsed, the user is asked if he or she are still hungry at step S5440. If the user is still hungry, he or she may return to step S5000 to begin consumption of a second serving with the assistance of the consumption speed regulator 2820 (FIG. 2) as described with reference to FIG. 7. If the user's hunger has subsided, the consumption regulator will return to begin meal countdown at step S4100.

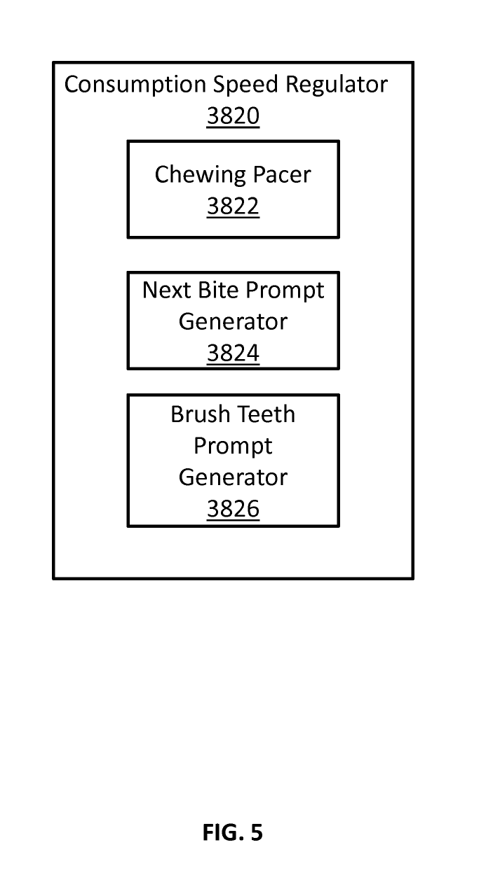

An alternate embodiment of consumption speed regulator 3820 is depicted in FIG. 5. In this embodiment, consumption speed regulator 3820, in addition to a chewing pacer 3822 and a next bite prompt generator 3824, includes a brush teeth prompt generator 3826, which prompts the user to brush his or her teeth after completing consumption of their meal. Alternatively, the consumption regulator may include a separate brush teeth component (not shown) which will be activated by meal schedule component 2840 (FIG. 2) through consumption manager 2100 at a time during first delay S4200 or the brush teeth prompt generator may be a sub-component of meal schedule component 2840.

While the user is prompted to hydrate an amount of time prior to meal consumption, a hydration schedule component 2860 may make use of the hydration prompt generator 2600 and timer 2500 to prompt the user to hydrate at other times according to a schedule developed based upon the user's profile 2400. As with the meal schedule component 2840, the above hydration prompts may include alerts such as audible beeps, vibrations or blinking lights in combination with a verbal message. Verbal messages may be audible, readable or both and may include, for example, “Drink fluids now!”

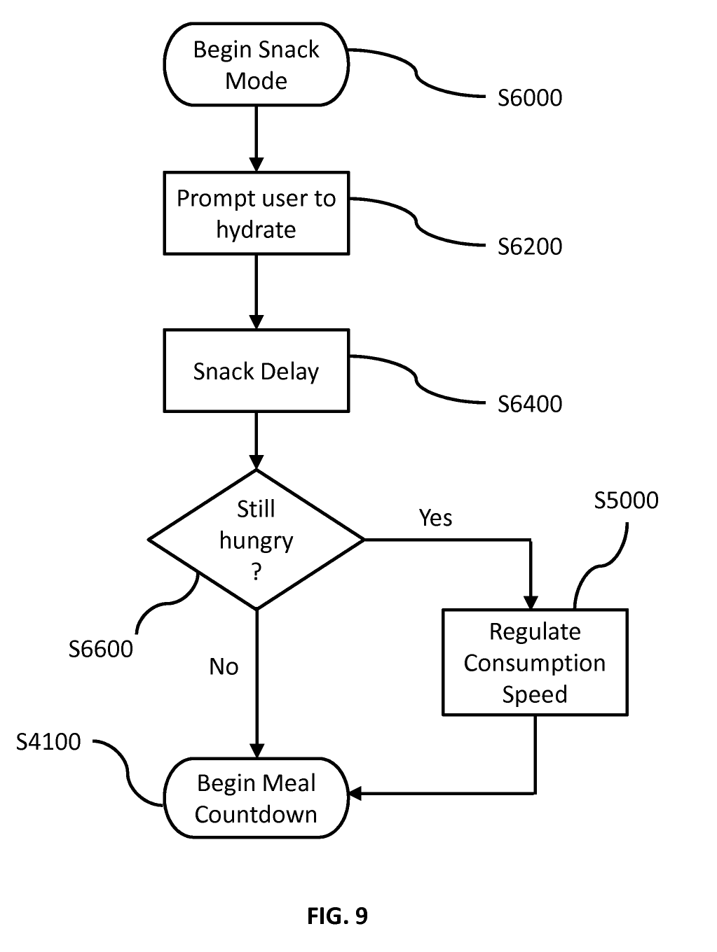

If the user feels hungry at a time not corresponding with an optimal time established within meal schedule component 2840 (FIG. 2), he or she can provide input indicating this into input 2700 and a snack mode is initiation as depicted at S6000 of FIG. 9. Sensing that the time is not right for consumption of a meal in accordance with the meal schedule component 2840, a snack component 2880 signals the hydration prompt generator 2600 through consumption manager 2100 at a step S6200 to prompt the user to hydrate. After the hydration prompt at step S6200, the snack component 2880 begins a snack delay at step S6400 during which the timer 2500 counts down through a predetermined snack delay. After elapse of the snack delay, snack component 2880 requests the user provide input indicating whether the user is still hungry at step S6600. If the user is still hungry, they may begin consumption of a snack with the assistance of consumption speed regulator 2820 by the process S5000. If the user is not hungry, the consumption regulator returns to begin meal countdown step S4100 according to the meal schedule component 2840.

The processes and steps depicted by way of example in the flowchart illustrations of FIGS. 6-9 may be implemented by a computing device system or other programmable data processing apparatus interpreting and executing instructions stored as computer readable program code on one or more computer readable storage media or one or more computer readable signal media. Each block in the flowchart illustrations may represent a module, segment, or portion of computer readable program code, which comprises one or more executable instructions for implementing the depicted logical function(s). It should also be noted that, in some alternative implementations, the functions noted in the block may occur out of the order noted in the flowchart illustrations. For example, two blocks shown in succession may, in fact, be executed substantially concurrently, or the blocks may sometimes be executed in the reverse order, depending upon the functionality involved. It should also be noted that each block of the flowchart illustrations, can be implemented by special purpose hardware-based systems that perform the specified functions or acts, or combinations of special purpose hardware and computer executable instructions.

Returning to the example depicted in FIG. 2, consumption regulator 2000 may also include a food diary component 2200 and an exercise tracker 2300.

The food diary component 2200 is capable of storing information about foods consumed by the user and may include a built-in library containing a number of food entries and information associated with the food entries such as calories contained in the foods. By this built-in library, the user can select the foods they have consumed. The food diary component 2200 is capable of communicating foods consumed by the user to the consumption manager 2100 which may relay this information to the profile 2400 for updating of user information or to meal schedule component 2840 for changing the user's meal consumption schedule. In some embodiments, information received by the food diary component 2200 may be communicated through the consumption manager 2100 to the consumption speed regulator 2820 to change the pace of the chewing pacer 2822 or to change the length of the next bite delay at step S5210.

The exercise tracker 2300 is capable of storing information about exercise performed by the user and may include a built-in library containing a number of exercise entries and information associated with the exercise entries such as calories burned by the exercises per given amount of time. By this built-in library, the user can select the exercises he or she has performed. The exercise tracker 2300 communicates exercises performed by the user to the consumption manager 2100 which may relay this information to the profile 2400 for updating of user information or the meal schedule component 2840 for changing the user's meal consumption schedule. In some embodiments, information received by the exercise tracker 2300 may be communicated through the consumption manager 2100 to the consumption speed regulator 2820 to change the pace of the chewing pacer 2822 or to change the length of the next bite delay at step S5210 (FIG. 7).

If the user is in a restaurant, is a guest at a dinner party or is hosting a dinner party, they may prefer to adjust the perceivability of the various prompts of the consumption regulator. Thus, the consumption regulator may be provided with a discretion mode in which the various prompts are only perceivable by the user. For example, during chewing pacing, the aforementioned throbbing vibration may be used to pace chewing of the pacer rather than the audible beep.

In some embodiments, a restaurant component (not shown) is capable of analyzing a restaurant menu to establish healthy options for the user. For example, the computing device 1000 (FIG. 1) may have access, by wired or wireless Internet access, to restaurant menus published on the world wide web. By analyzing the menu according to pre-programmed criteria, the consumption regulator is able to recommend against, for example, consumption of fried options or options having rich sauces. As an alternative, the user may be able to enter individual options from the restaurant menu for healthy comparison by the consumption regulator.

In some embodiments, a smoking cessation component (not shown) is provided with the consumption regulator either integral with the consumption regulator or as an add-on component. The smoking cessation component uses pre-programmed criteria and input provided by the user to establish a period of time over which the user will be weaned from their smoking habit. Each day, the user will receive a decreasing frequency of prompts allowing them to smoke. When used in conjunction with the food consumption components and hydration schedule component 2860 (FIG. 2) of the consumption regulator, the user will be able to successfully quit smoking without adding body weight. Additionally, the smoking cessation component may provide the user with hints, tips and tricks for cessation of smoking.

While the technology has been described with respect to certain specific embodiments, it will be appreciated that many modifications and changes may be made by those skilled in the art without departing from the spirit and scope of the invention. Different embodiments or various aspects thereof may be combined to yield additional embodiments. It is intended by the appended claims to cover all such modifications and changes as fall within the true spirit and scope of the invention.

What is claimed is:

1. An apparatus for regulation of user consumption, comprising:
a processor;
a memory component;
an input/output component;
a hydration schedule component;
a meal schedule component including one or more meal prompt configured to present one or more meal prompts at times relevant to consumption of meals;
a consumption speed regulator including a chewing pacer configured to present perceivable pulse that repeats a pre-determined number of times; and
a profile component configured to present information and providing the information to at least the hydration schedule component and the meal schedule component for respective scheduling of hydration prompts and meal prompts.

2. The apparatus of claim 1, wherein the one or more meal prompt generators include:
warning prompt generators capable of presenting warning prompts at pre-determined intervals prior to optimum times for meal consumption; and
a begin consumption prompt generator configured to present a begin consumption prompt at the optimum times for meal consumption.

3. The apparatus of claim 1, wherein:
the consumption speed regulator includes a next bite prompt generator capable of presenting a next bite prompt a pre-determined interval after the pre-determined number of repetitions of the perceivable pulse.

4. The apparatus of claim 1, further comprising:
a food diary component capable of storing information about foods consumed.

5. The apparatus of claim 1, further comprising:
an exercise tracker component capable of storing information about exercise performed.

6. The apparatus of claim 1, further comprising:
a snack component capable of presenting at least one snack consumption delay prompt for delaying snack consumption.

7. The apparatus of claim 6, further comprising:
a hydration prompt generator capable of presenting a hydration prompt in response to a signal from any one of the hydration schedule component, the meal schedule component or the snack component.

8. An computer-implemented method for regulation of user consumption, comprising:
storing information in a profile;
generating a meal schedule according to the information;
generating a hydration schedule according to the information;
prompting at times relevant to consumption of meals according to the meal schedule;
pacing chewing of with a perceivable pulse; and
repeating the perceivable pulse a pre-determined number of times.

9. The computer-implemented method of claim 8, wherein prompting at times relevant to consumption of meals includes:
presenting warning prompts to at pre-determined intervals prior to optimal times for meal consumption; and
presenting begin consumption prompts to the optimal times for meal consumption.

10. The computer-implemented method of claim 8, further comprising:
presenting a next bite prompt a pre-determined interval after repeating the perceivable pulse the pre-determined number of times.

11. The computer-implemented method of claim 8, further comprising:
storing information about foods consumed in a food diary.

12. The computer-implemented method of claim 8, further comprising:
storing information about exercise performed in an exercise tracker.

13. The computer-implemented method of claim 8, further comprising:
presenting at least one snack consumption delay prompt to delay snack consumption.

14. The computer-implemented method of claim 13, further comprising:
presenting a hydration prompt in accordance with any of the hydration schedule, the meal schedule or snack consumption delay prompt.

15. An computer program product for regulating user consumption, the computer program product comprising:
a non-transitory computer readable storage medium having encoded thereon:
first program instructions executable by a computer to cause storage of information in a profile;
second program instructions executable by a computer to cause generation of a meal schedule according to the stored information;
third program instructions executable by a computer to cause generation of a hydration schedule according to stored the information;
fourth program instructions executable by a computer to cause presentation of prompts to at times relevant to consumption of meals according to the generated meal schedule; and
fifth program instructions executable by a computer to cause both generation of a perceivable pulse for pacing chewing and repetition of the perceivable pulse a pre-determined number of times.

16. The computer program product of claim 15, wherein the fourth program instructions are executable by a computer to cause presentation of prompts to at times relevant to consumption of meals according to the generated meal schedule further include:
instructions executable by a computer to cause presentation of warning prompts at pre-determined intervals prior to optimal times for meal consumption; and
instructions executable by a computer to cause presentation of begin consumption prompts at the optimal times for meal consumption.

17. The computer program product of claim 15, wherein the fifth program instructions executable by a computer to cause both generation of a perceivable pulse for pacing chewing and repetition of the perceivable pulse a pre-determined number of times further include instructions executable by a computer to cause presentation of a next bite prompt to a pre-determined interval after repetition of the perceivable pulse the pre-determined number of times.

18. The computer program product of claim 15, further comprising:
seventh program instructions executable by a computer to cause storage of information about foods consumed; and
eighth program instructions executable by a computer to cause storage of information about exercise performed.

19. The computer program product of claim 15, further comprising:
sixth program instructions executable by a computer to cause presentation of a snack consumption delay prompt.

20. The computer program product of claim 19, further comprising:
ninth program instructions executable by a computer to cause presentation of a hydration prompt in response to any of the hydration schedule, the meal schedule or the snack consumption delay prompt.
